(19) United States
(12) Patent Application Publication
(10) Pub. No.: US 2020/0298156 A1
(43) Pub. Date: Sep. 24, 2020

(54) LAYERED PANELS WITH STRUCTURES FOR SEPARATION

(71) Applicant: Imagine TF, LLC, Campbell, CA (US)

(72) Inventor: Brian Edward Richardson, Los Gatos, CA (US)

(21) Appl. No.: 16/825,078

(22) Filed: Mar. 20, 2020

Related U.S. Application Data
(60) Provisional application No. 62/919,620, filed on Mar. 20, 2019.

(51) Int. Cl. B01D 46/00

(52) U.S. Cl. CPC B01D 46/0001; B01D 15/22; B01D 46/002

(57) ABSTRACT

Devices for the separation of components within a fluid are disclosed herein. The device includes a housing that typically includes at least one separation panel formed from multiple layers. The separation panels are formed with channels having functionalized surfaces to attract and retain selected components within the fluid. The separation panels include a physical boundary to contain the fluid flow.

### CROSS REFERENCE TO RELATED APPLICATIONS

This application claims priority of Provisional Application filing No. 62/919,620, filed Mar. 20, 2019. The disclosure of that application is hereby incorporated herein by reference in its entirety.

### FIELD OF THE DISCLOSURE

The present disclosure relates generally to separation devices, and more particularly discloses fluidic architectures for the separation of one or more components from a fluid.

### SUMMARY

In various embodiments of the present disclosure, separation devices include a housing and at least one separation panel. Both the separation panel and the housing have an inlet side and an outlet side. The separation panel further includes a base or substrate, and ribs or walls that form channels in the separation panel. The separation panel channels are fully enclosed by mating the top surface of the ribs or walls to a neighboring surface. This surface could be the bottom of another separation panel or a housing component. The fluid requiring separation flows into the channels from the inlet port and the inlet plenum. The fluid exits the channels from the outlet plenum and the outlet port. It should be noted that the fluid could be either a gas or a liquid and, in some cases, solid particles that can be made to flow in a fluidic path.

The surfaces of some or all of the separation panels may be either the base material or a coating that interacts with the fluid. The interaction would generally be to attract a component within the fluid. By attracting the component or components to a surface, the components are removed from the fluid completely or are reduced in quantity in the fluid.

This type of component removal is commonly used in water filtration processes to remove unwanted chemicals. Chromatography is another area where this concept is utilized. Drug process chromatography utilizes surface attraction to separate a specific component from a “soup” of many components. In most cases that involve extracting one or more components from a fluid, the separated component is the component of interest. After separation process, the target component is retrieved in a second process where a wash fluid is run though the device that eliminates the attraction of the component to the surface thereby releasing the component into a solution with the wash fluid.

Analytical chromatography adds an additional timing constraint to a separation process. Analytical chromatography is used to separate a large number of components within a solution from one another over time. To maintain the timing of component removal, the flow through all areas of the separation device has to be consistent. Therefore all the fluid flow paths within the device must have similar lengths and resistance.

### BRIEF DESCRIPTION OF THE DRAWINGS

The accompanying drawings, wherein like reference numerals refer to identical or functionally similar elements throughout the separate views, together with the detailed description below, illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a perspective view of the separation device.

FIG. 2 is a perspective view of the separation device shown in FIG. 1 with the top housing removed to expose the internal components.

FIG. 3 is a top view of the separation device with the top housing removed.

FIG. 4 is a closeup perspective view of a portion of the internal components shown in FIG. 2.

FIG. 5 is a magnified view of a section of the components shown in FIG. 4.

FIG. 6 illustrates one of the panels that form the separation device.

FIG. 7 is a closeup top view of a separation panel.

FIG. 8 is a perspective view of an alternate embodiment of the separation device.

FIG. 9 is a perspective view of the separation device disclosed in FIG. 8 with the top housing removed to expose the internal components.

FIG. 10 is a top view of the device illustrated in FIG. 9.

FIG. 11 shows the internal components of the device.

FIG. 12 is a closeup view of the internal components.

FIG. 13 is a top view of the inlet section of the device showing fluid flow paths through the device.

FIG. 14 is a top view of the outlet section of the device showing fluid flow paths through the device.

FIG. 15 is a top view of the inlet section of an alternate embodiment of the device showing fluid flow paths through the device.

FIGS. 16A and 16B are top views of the inlet section of an alternate embodiment of the separation device.

FIG. 17 is a perspective view of a “generic” device used to illustrate the overall aspect ratios of dimensions of the device.

FIG. 18 is a perspective view of an alternate embodiment of the separation device with an inverted aspect ratio.

FIG. 19 is a top view of the separation device illustrated in FIG. 18.

FIG. 20 is a perspective view of an alternate embodiment of the separation device with only one separation panel layer.

FIGS. 21A, 21B and 21C show cross sectional views of a section of the device with functional surfaces.

FIG. 22 is a perspective view of an alternate embodiment of the separation device sectioned to show the internal components.

FIG. 23 is a perspective view of the circular separation panel utilized in the device illustrated in FIG. 22.

FIG. 24 is a closeup view of the separation panel shown in FIGS. 23.

### DETAILED DESCRIPTION

The present disclosure is generally directed to configurations of separation devices that are utilized to separate a particular component from a fluid, either gas, liquid, or solid particles that have fluidic characteristics. Separation panels used in the devices deploy ribs to create walls and channels for fluids to flow from an inlet area to an outlet area through the separation device. The separation panels are stacked to form the device. The panels described herein are not in communication with each other, that is to say, there are no through holes in the panels themselves. The only communication between the layers is at the inlets and outlets of the device. This allows different manufacturing techniques to be utilized, such as forming the channels in a plastic film and then stacking multiple films. This technique is an alternative to etching processes.

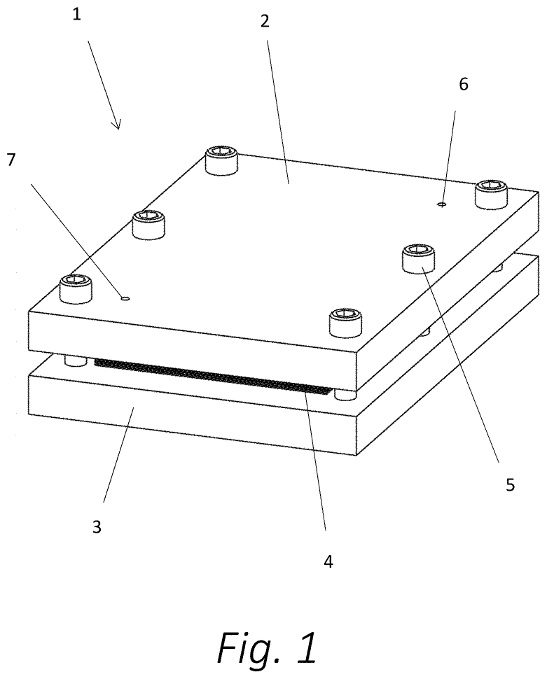

Referring first to FIG. 1, the separation device 1 is shown with a top housing 2 and a bottom housing 3 which clamp in place separation panels 4. The clamping force is provided by screws 5 in the housing 2, 3. One skilled in the art of housing design could conceive of many other variations of housings that would provide the necessary clamping force for the separation panels 4.

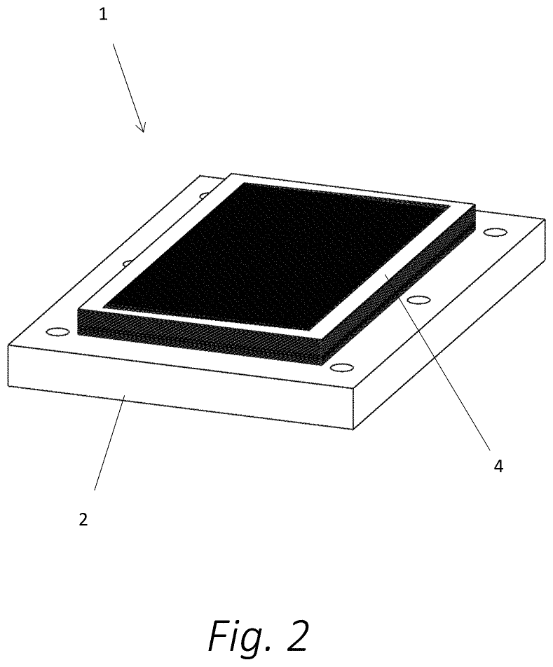

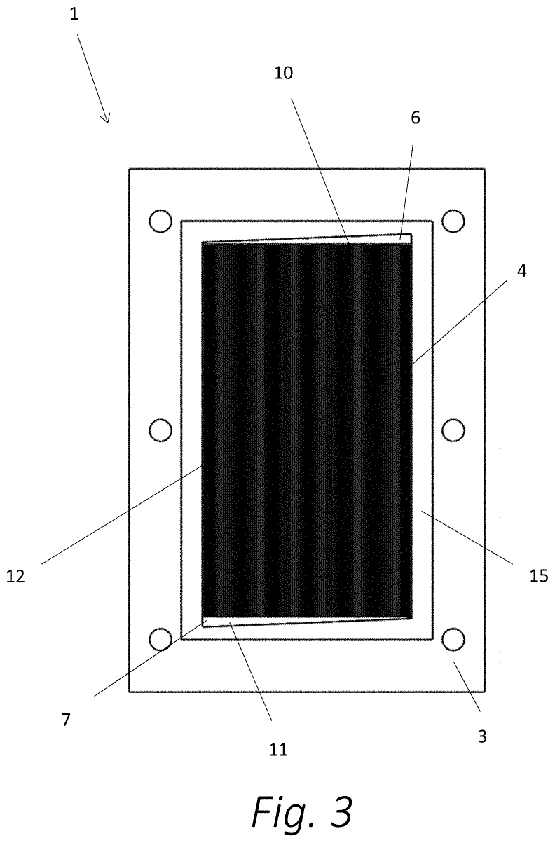

The top housing 2 has an inlet port 6 and an outlet port 7. These ports 6, 7 direct fluids to and from the internal plenums inside the separation device 1. In FIGS. 2 and 3, the top housing 2 is removed so that the internal features are readily visible.

As is illustrated in FIG. 3, an inlet plenum 10 is a trapezoid shaped volume. The base of the trapezoid extends across the width of the channels 12 within the separation panel 4. The significance of the geometry of the inlet plenum 10 will be discussed below. The locations of the inlet port 6 and outlet port 7 are shown for reference purposes and they are at opposite ends of the separation device 1. The inlet port 6 is located above the taller end of the inlet plenum 10 to deliver fluid to the inlet plenum 10. The fluid flows from the inlet port 6 to the inlet plenum 10 and then to the channels 12. The fluid then exits the channels 12 via the outlet plenum 11 and out the outlet port 7 (visible in FIG. 1).

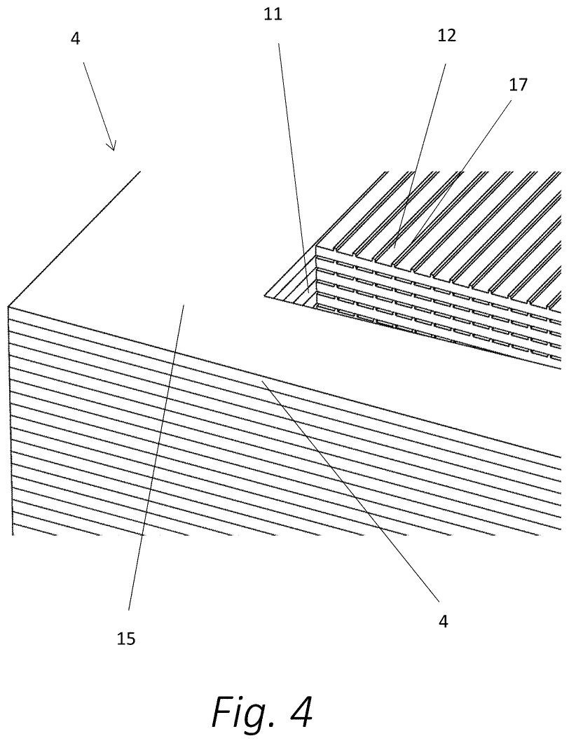

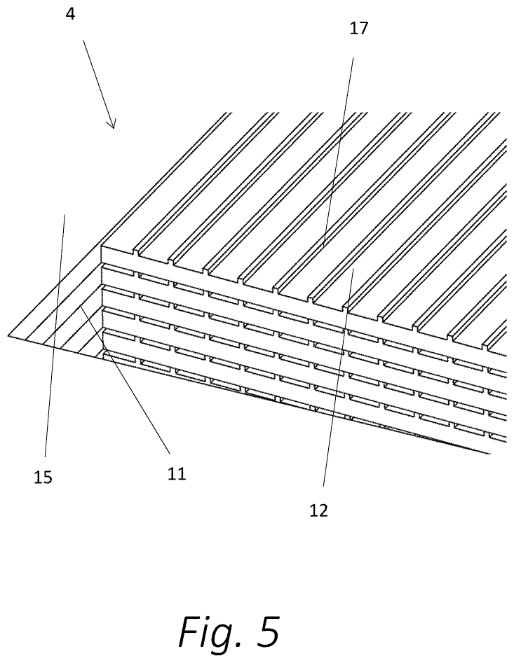

FIGS. 4 and 5 show the channels 12 in greater detail. The channels 12 are generally equal in width and height. It should be noted that the top side of the channels are constrained by the top cover 2, not shown. The top surfaces of the walls 17 that create the side of the channels 12 are planer with the top surface of the border 15. This relationship ensures that the top housing 2 provides an upper boundary for the fluid flows within the channels 12 and also within the plenums 10, 11. In some separation applications the pressure within the separation device 1 needs to be relatively high, on the order of 10,000 PSI.

The layered nature of the separation panels 4 is apparent in the various figures of the drawings. The plenums 10, 11 extend from a bottom surface of the top housing 2 to a top surface of the bottom housing 3. This configuration allows fluid to flow from the inlet areas to all of the channels 12 within the separation device 1. As mentioned above, with some applications it is critical that the flow in these channels be very nearly equal. Plenums are a known mechanism to deliver fluids to a number of channels at equal pressure and volume. FIG. 5 further illustrates the entirely constrained channels 12. The bottom surface of a given separation panel 4 creates an upper constraint for the separation panel 4 below it. Depending on the application in which the separation device 1 is being utilized, the number of separation panels 4 in the device would range from one to hundreds or even thousands.

The dimensions chosen for the channels 12 in a given device depend on the characteristics of the fluid and the component being separated from the fluid. The diffusion rate of the component in the fluid and the velocity of the flow are the main factors that drive the selection of channel dimensions. Small dimensions are typically preferred for separation devices. Smaller dimensions create proportionally more surface area for the accumulation of attracted components within a separation device. Smaller dimensions also produce a smaller distance for a component to diffuse to and be retained at a surface of a channel 4. A typical channel size for high pressure liquid chromatography (HPLC) separation devices is on the order of 1.5 micron to 2 microns. Manufacturing and flow constraints limit the size that is feasible for channels in the current art. The structures and methodology disclosed herein essentially remove those limitations to channel size.

Using the configurations described herein, current semiconductor processing equipment can create separation channels at a one atomic scale. This factor allows for extremely accurate and consistently sized channels. It also allows for the creation of almost any sized channels desired by the user. Separation panels 4 can be fabricated by semiconductor processing and/or they can be molded from a semiconductor master. Further, a secondary or tertiary mold can be made from a semiconductor master to mold separation panels 4. Separation panels 4 would preferably be fabricated from a polymer (plastic). Polymer panels can be molded with a number of molding techniques—compression molding, injection molding, roll to roll molding, hot embossing, or UV curing of structures are all feasible. Equipment utilized to manufacture CD/DVDs can be used to manufacture separation panels. Polymers can also be molded with roll to roll equipment and cut into panels. Some gift-wrapping material has nanometer scale features formed by roll to roll manufacturing that create color by diffraction. The creation of nanometer scale structures on a film for gift-wrapping demonstrates the cost effectiveness of roll to roll manufacturing.

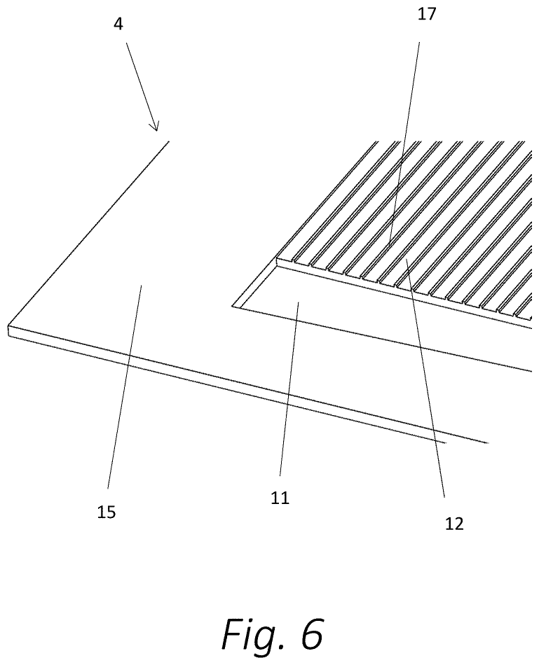

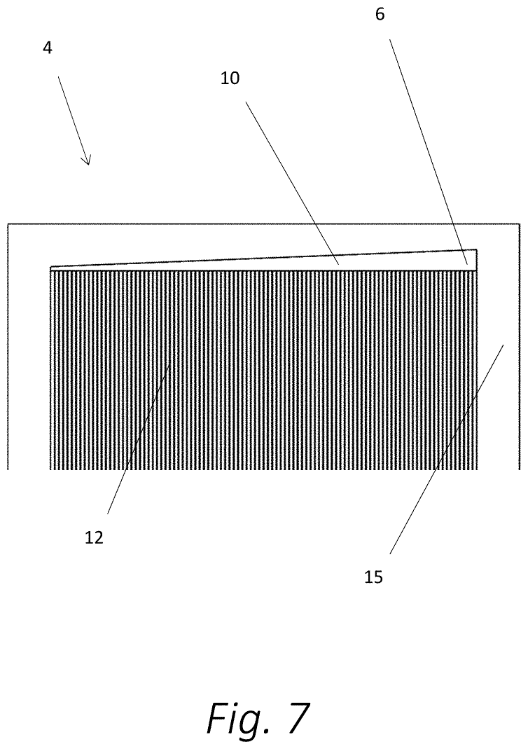

FIGS. 6 and FIG. 7 show further views of a single separation panel 4 so that the interior components can be readily seen.

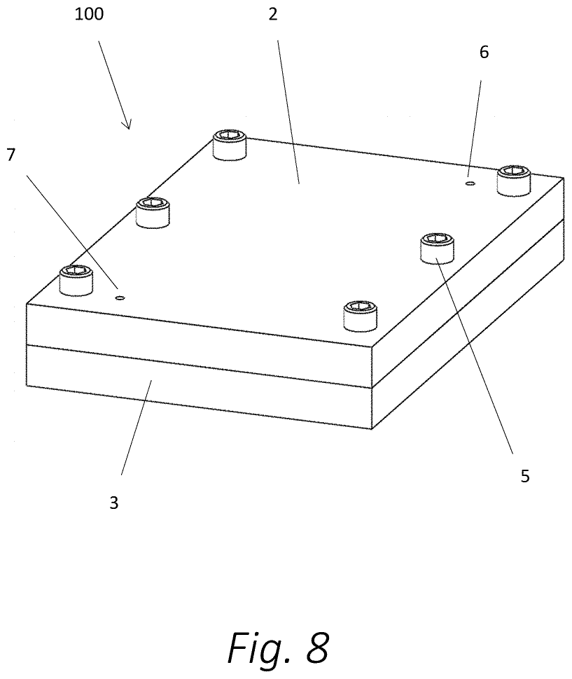

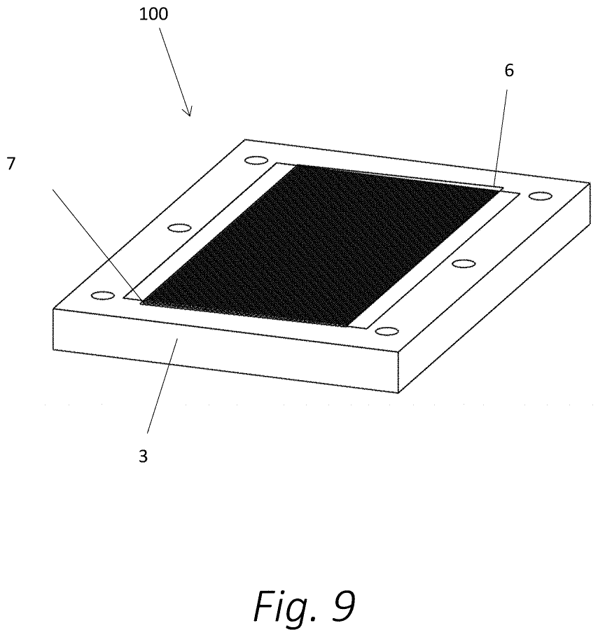

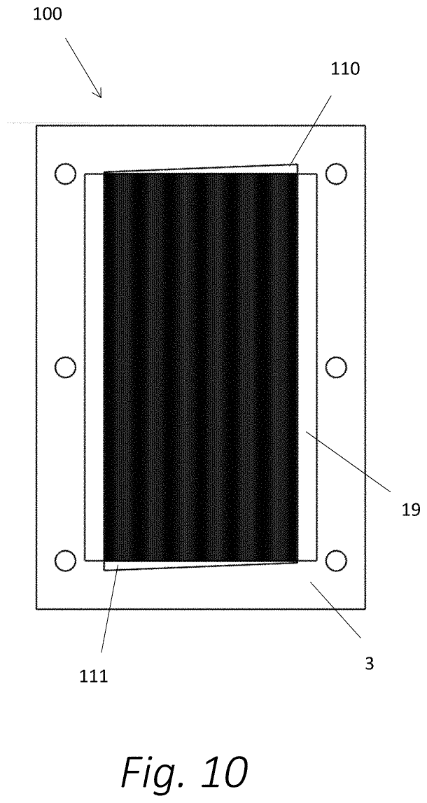

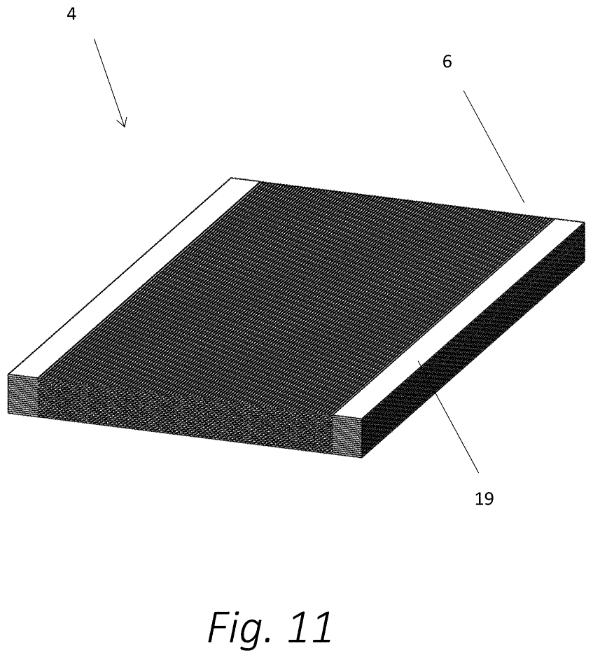

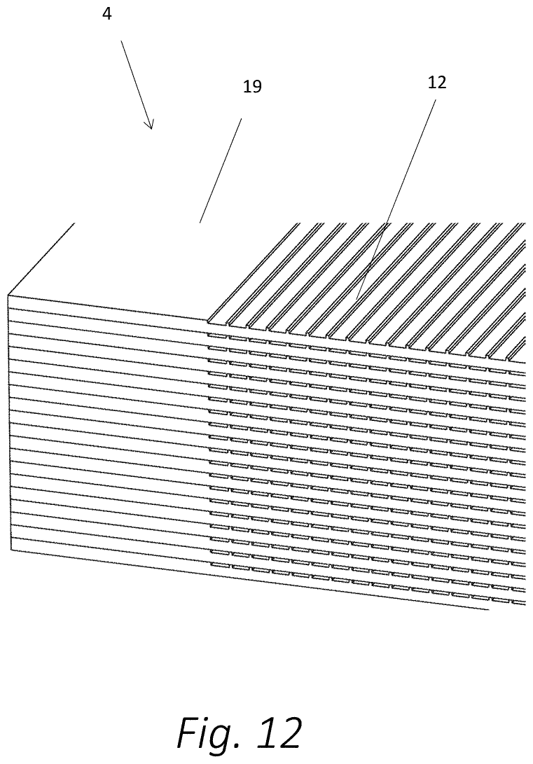

FIGS. 8-12 show a slightly modified version of a separation device. In FIG. 11, a modified housing uses side borders 19 to enclose the separation panels 4. In the preferred embodiment described above, the inlet and outlet plenums 10, 11 are formed by the separation panels 4. In the alternate embodiment of the device 100 depicted in FIGS. 8-12, the plenums 110, 111 are formed by the housing structure 102, 103 itself. The fluidic architectures of the two embodiments are identical. Only the configuration of the components that create the plenums 110, 111 are different.

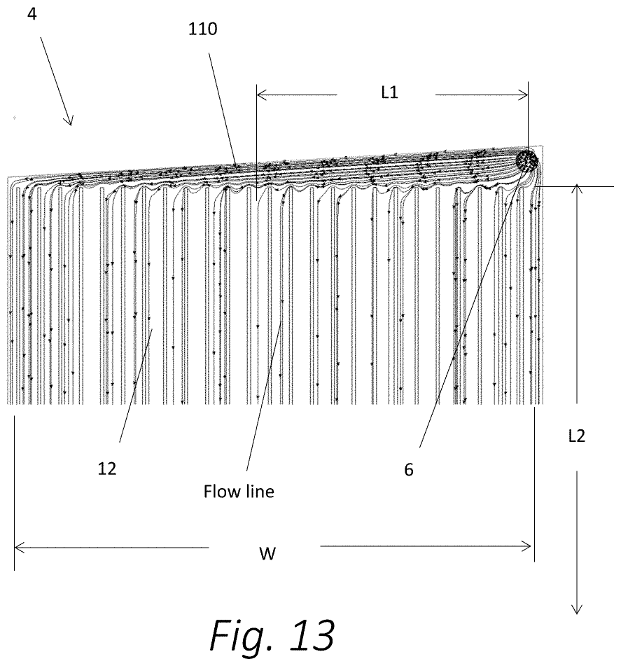

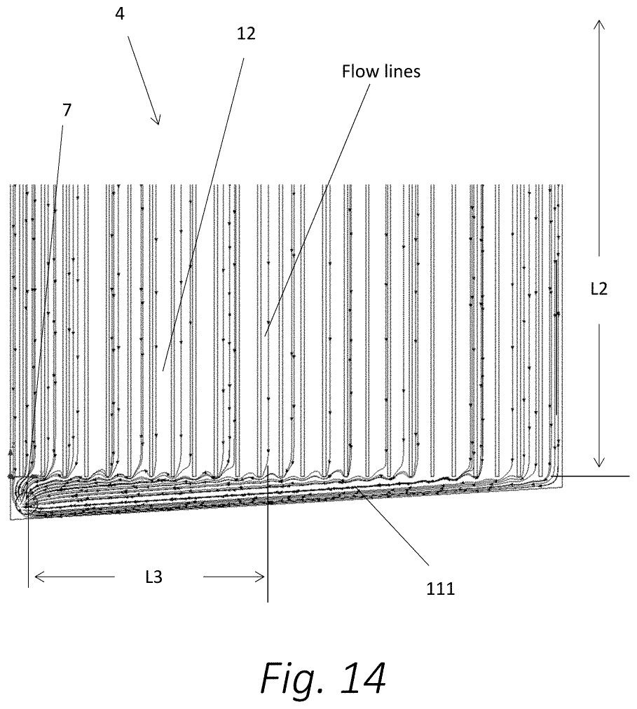

FIGS. 13 and 14 show the flow lines of the fluid as it flows through the inlet plenum 110 to the outlet plenum 111 and one separation panel 4. With some separation operations it is desirable that the fluid path lengths be as close to equal as possible. The configurations illustrated herein provide generally equal path lengths. The path length of the flow generally equals the distance the fluid flows to the left from the inlet to the point it enters a channel, L1 plus the total length of the channel, L2 plus the length from the exit of the fluid from the channel to the exit, L3. In all cases L1 plus L2 equates to the width between the inlet and outlet of the device, W. Both L2 and W are constant. Therefore, the path length for all flow paths through the device are generally equal.

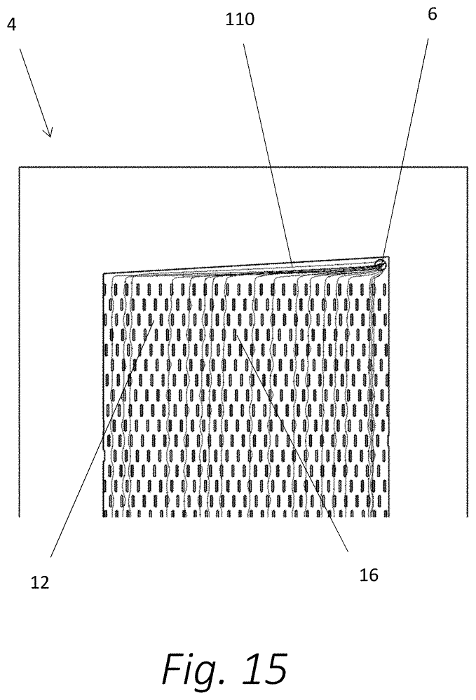

FIG. 15 illustrates an alternate method of forming the channels 12. By segmenting and staggering the walls that create the channels 12, more cross sections “cut” the fluid path. This embodiment might be deployed for the separation of larger sized compounds. Small, molecular sized compounds diffuse within the fluid at a much higher rate than large molecules. By staggering the structures 16, the distance that a compound located near the center of the channel needs to diffuse to reach a wall is reduced. Further, the structures 16 could all be in line with one another. This configuration would not result in more “cuts” (during the manufacturing process) but it would create more surface area by exposing the ends of the structures 16.

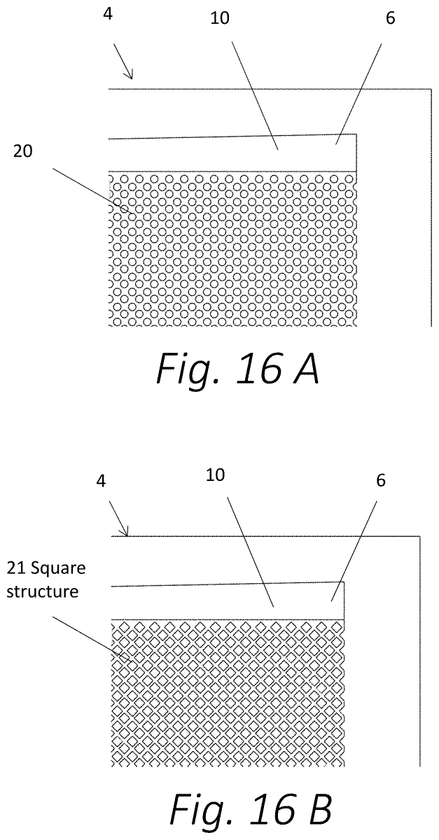

FIGS. 16A and 16B illustrate two alternative structures of wall structures 20, and 21. These structures provide an alternative to the use of continuous walls to form the separation channels extending from the inlet to the outlet plenums. It should be noted that one skilled in the art of engineering microfluidic structures could conceive of multiple variations for the configuration of the channel defining structures.

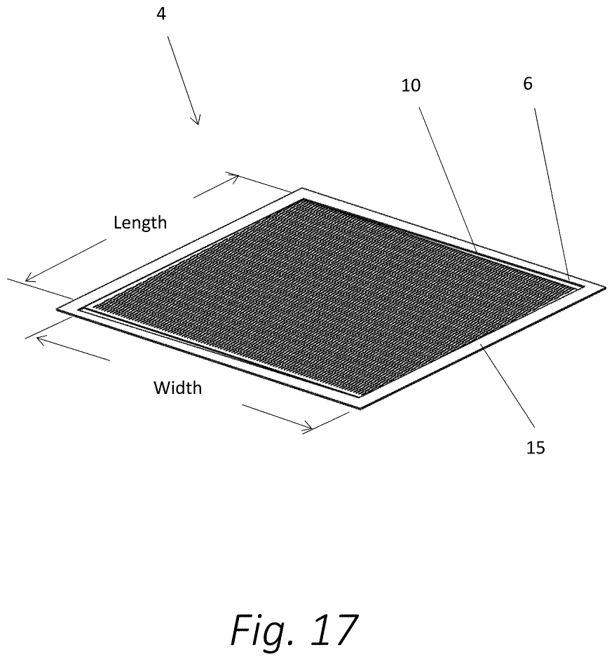

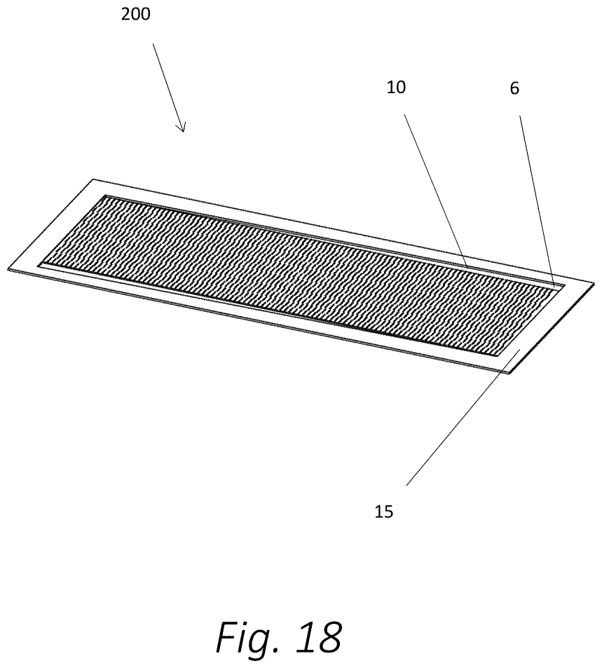

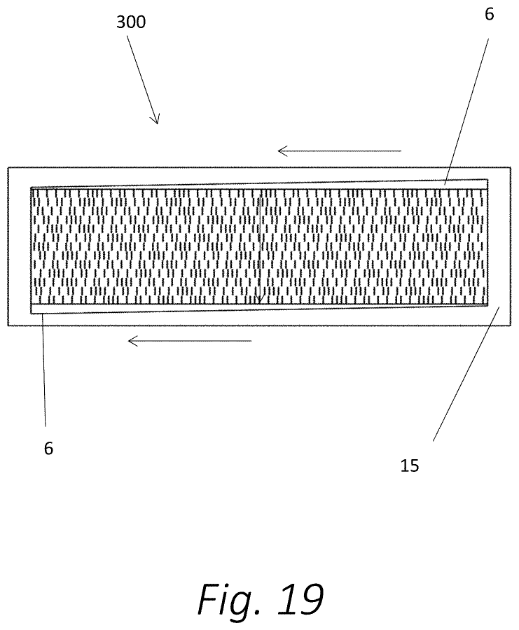

FIG. 17 illustrates the relationship of the length to the width of the separation panels 4. As mentioned above, with some types of separation devices, the length of the fluid path is critical. Most prior art devices used in these applications use a packed bed of spheres, resulting in inherent inconsistencies in diameter and packing. These inconsistencies must lead to variation in flow rates across the width of the flow path. To reduce the effect of this variation, the width of the device is typically much smaller than the length. The structures described herein are fabricated with extremely high, single digit nanometer accuracy. This accuracy almost entirely eliminates flow variations from channel to channel. Therefore, the width of the device can be much larger in relation to the length as compared to current art devices. By reducing the length and increasing the width the pressure required to drive the fluid flow is reduced. Current packed bend devices require many thousands of pounds per square inch of pressure. The devices described herein are designed to operate at one or two orders less pressure than current art devices. This factor allows the construction of separation devices whose width is in fact much greater than its length. FIGS. 18 and 19 show examples of separation panels 200 and 300 whose width is greater than their length.

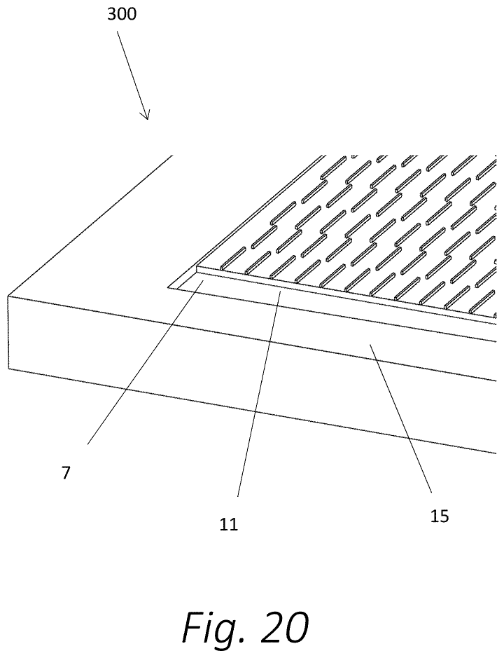

FIG. 20 shows still another alternate embodiment of a separation panel 300 is disclosed. The separation panel 300 is configured for use in a single or a two panel separation device. Note that the thickness of panel 300 is greater than other separation panels. The increased thickness allows for a plenum that does not extend through the thickness of the panel. This configuration eliminates the contact of fluids to the bottom housing, not shown. This also eliminates the need to seal the device at the panel to bottom housing interface. Another embodiment of the panel 300 would be to mate the panel 300 to a mirror image panel. By mating two mirrored panels to one another the flow and surface area would be doubled. This architecture would require input and output ports to supply and extract fluids from the plenums of both mirror image panels.

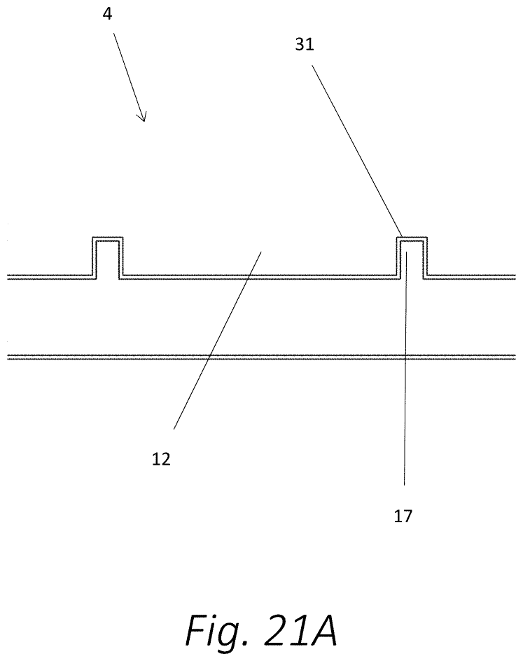

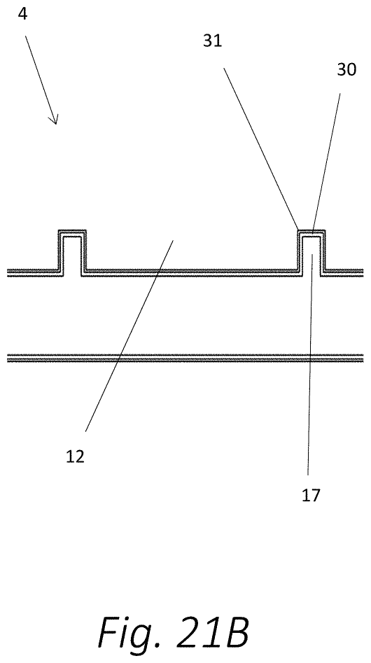

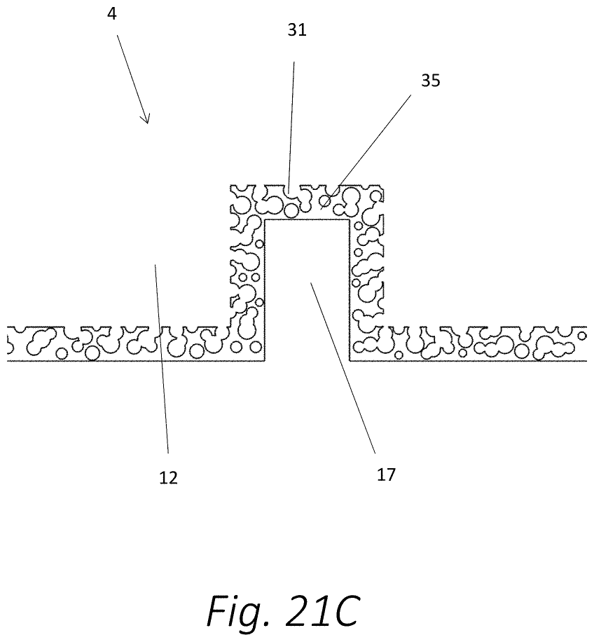

FIG. 21A shows a cross section of a typical separation panel. As mentioned above, a polymer might be used to construct the separation panel. A polymer that is ideal for film manufacturing of separation panels might not be the ideal material for the attraction of compounds in the subject solution. To alleviate this problem, a material that is ideal for the desired separation is applied to the surface of the separation panel to create a functionalized surface 31. The functionalized surface 31 has been coated with a material that facilitates the desired separation process. Applying a coating film is in many cases easier than coating prior art micron scale spheres. There are many conventional art devices and equipment available to coat film in a roll to roll process.

FIG. 21B shows an additional “primer” coat 30 applied to the separation panel to facilitate the bonding of the functionalized surface 31 to the separation panel 4. Many HPLC devices utilize silica spheres as the base structure that is functionalized. To utilize the current functionalized processes, a primer 30 of silica can be applied to the separation panels. One skilled in the art of “primers” and functionalization surfaces could engineer many materials to meet a specific separation task.

FIG. 21C shows a separation panel with a porous material 35 applied to the surfaces of the panel 4. The functionalized material 31 is applied to the surface of the porous material 35. A porous material is used in the separation device when increased separation surface area is required.

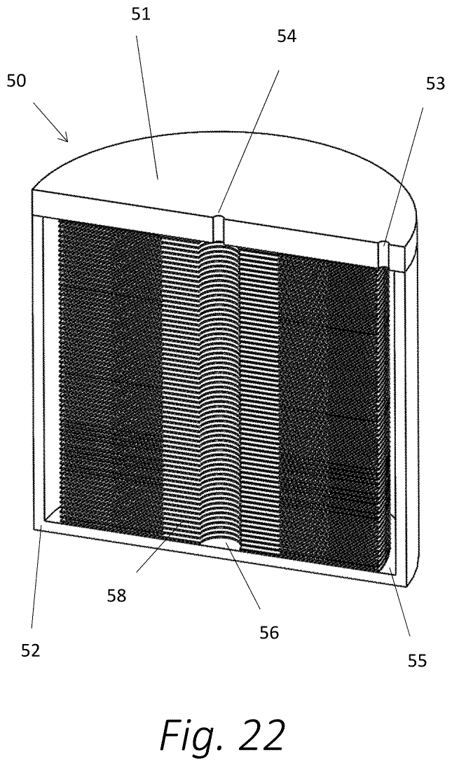

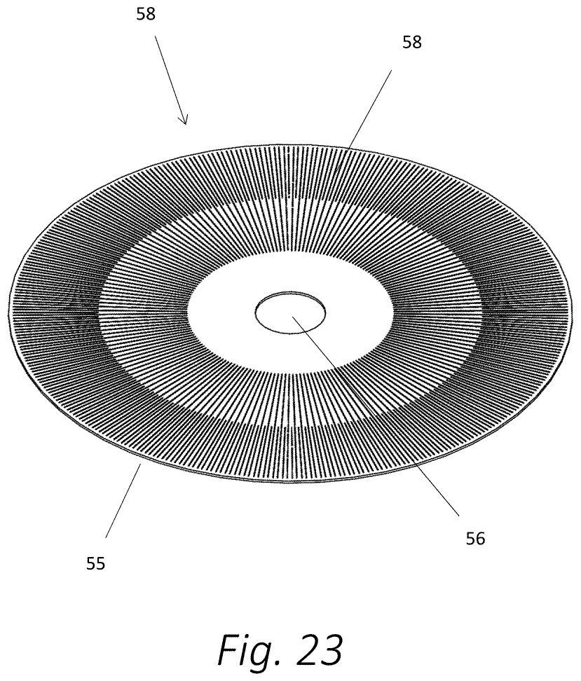

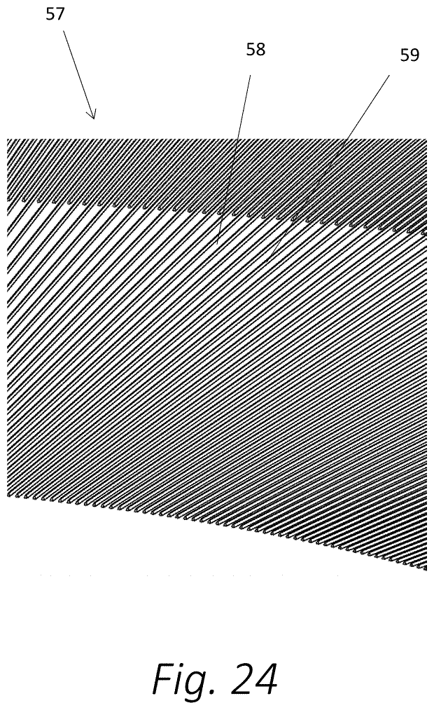

Referring now to FIGS. 22, 23, and 24, an alternate “radial” embodiment of a separation device 50 is disclosed. The radial architecture of the device 50 provides radial separation channels 58 on disk panels. Radial embodiments can utilize manufacturing equipment used by the CD/DVD industry. In various radial embodiments, a top cover 51 and a lower housing 52 form a cylindrical housing for the separation device 50. The device 50 includes an inlet 53 in the housing and an inlet plenum 55 to supply fluid flow to the radial channels 58. The fluid flows from an outer circumference across the circular panels to the center of the device 50. The fluid is collected in an outlet plenum 56, and exits the device 50 via an outlet 54 in the housing.

The technology disclosed herein addresses improved configurations for separation devices. The improvements disclosed are independent of the actual surface material used to achieve the separation process. There is a myriad of choices that would suffice as the material from which to form the separation panels and coatings on their surfaces. Further, the type of material used to create the separation panels is not limited to plastic or semiconductor material. Glass or metals could be deployed. It should be self-evident that one skilled in the art of catalytic materials could engineer a specific catalytic material to be used for separation to be used in a given application.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprise” and/ or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

In the foregoing description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A separation device, comprising:
an inlet port and an inlet plenum;
an outlet port and an outlet plenum;
at least one separation panel; and
a housing constraining the at least one separation panel; wherein
the at least one separation panel comprises separation channels that provide fluid flow paths from the inlet plenum to the outlet plenum.

2. The separation device of claim 1, wherein a plurality of separation panels are stacked on top of one another, the separation panels being solid so that fluid does not flow through an upper separation panel to a lower separation panel, the separation panels receiving fluid flow via the inlet plenum only.

3. The separation device of claim 1, wherein a first separation panel is mated to second separation panel, the second separation panel being a mirror image of the first separation panel.

4. The separation device of claim 1, wherein the separation channels are defined by walls that do not extend the entire length or width of the separation channel.

5. The separation device of claim 4, wherein the walls are segmented structures, thereby creating additional surface area on the walls.

6. The separation device of claim 1, wherein the separation channels comprise surfaces that attract and retain selected components in a solution introduced into the device.

7. The separation device of claim 1, wherein the at least one separation panel and a width to length aspect ratio larger than 1.

8. The separation device of claim 1, wherein the separation channels have a porous surface.

9. The separation device of claim 1, wherein the separation channels have a surface coated with a selected material.

10. The separation device of claim 1, wherein the separation channels are coated with a primer.

11. The separation device of claim 1, wherein the primer is covered with a coating.

12. The separation device of claim 1, wherein the at least one separation panel is formed from a polymer substrate.

13. The separation device of claim 1, wherein the at least one separation panel is formed in a disk conformation with radial walls forming the separation channels such that radial flow paths are created.

14. The separation device of claim 13, wherein a plurality of the separation panels are stacked in a cylindrical housing.

15. The separation device of claim 1, wherein the separation channels selectively retain a component of an introduced fluid, the component then being released by introducing a second solution to the device.
